(19) United States
(12) Patent Application Publication
(10) Pub. No.: US 2025/0335473 A1
(43) Pub. Date: Oct. 30, 2025

(54) GEOENCODED IMAGE TOOLS THAT ASSOCIATE TEXTURAL DATA AND OBJECTS WITH LOCATION THROUGH IMAGE ANALYSIS

(71) Applicant: Nrby, Inc., Manchester, NH (US)

(72) Inventor: Jeremy Breau, Overland Park, KS (US)

(21) Appl. No.: 19/190,498

(22) Filed: Apr. 25, 2025

Related U.S. Application Data
(60) Provisional application No. 63/638,887, filed on Apr. 25, 2024.

(51) Int. Cl. G06F 16/29; G06F 16/587; G06V 10/70

(52) U.S. Cl. CPC G06F 16/29; G06F 16/587; G06V 10/768

(57) ABSTRACT

Geoencoded image tool that infers demographic information for a particular location from images, such as satellite images, street view images, and/or other geoencoded images. Aspects may include receiving a request from a user for demographic information for a geographic location, inferring the demographic information based on one or more images of the geographic location, and sending a response to the user with the inferred demographic information.

### CROSS REFERENCE TO RELATED APPLICATION(S)

This application claims the benefit of and priority to U.S. Provisional Application Ser. No. 63/638,887, entitled “METHOD AND PROCEDURE TO ASSOCIATE TEXTURAL DATA AND OBJECTS WITH LOCATION THROUGH IMAGE ANALYSIS” and filed on Apr. 25, 2024, which is expressly incorporated by reference herein in its entirety.

### INTRODUCTION

The present disclosure relates generally to the field of computer-implemented extraction of information from geoencoded images.

Geoencoded imagery may include images, or pictures, from sources such as satellite imagery, street view images, and other geographic data repositories. Such imagery provides a wealth of information about the physical characteristics of locations. Some methods of extracting information may include manual analysis or coarse statistical approximations. Aspects presented herein provides more efficient mechanisms for extracting information from such images.

### SUMMARY

Aspects presented herein provide mechanisms for the extraction of demographic data from geoencoded images that enable more efficient and accurate demographic information. For example, the extraction mechanisms provided herein provide more time efficient extraction and increase information precision, such as by avoiding imprecision that can be introduced through manual analysis or coarse statistical approximations of such information.

Aspects presented herein disclose a novel system and method for generating location-based demographic data by utilizing techniques applied to geoencoded imagery. In some aspects, the techniques may include artificial intelligence (AI) image analysis of geoencoded imagy. By employing advanced machine learning algorithms, the invention extracts demographic information such as age groups, gender distribution, socioeconomic status, and/or other relevant factors from images such as satellite images, street view images, and/or other geographic images. In some aspects, the method may involve processing the images through convolutional neural networks (CNNs) and other deep learning architectures to recognize patterns and features indicative of demographic characteristics in order to output a demographic analysis associated with a particular geographic location.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating an example system including various modules for providing demographic information inferred from images for a particular location, in accordance with various aspects of the present disclosure.

FIG. 2 is a diagram illustrating an example user interaction with a system that provides demographic information inferred from images for a particular location, in accordance with various aspects of the present disclosure.

FIG. 3 is a flowchart illustrating a method of providing demographic information inferred from images for a particular location, in accordance with various aspects of the present disclosure.

FIG. 4 is a block diagram of a computer system on which the disclosed system and method can be implemented, in accordance with various aspects of the present disclosure.

FIG. 5 illustrates an example network environment in which the demographic inference system may be implemented, in accordance with various aspects of the present disclosure.

### DETAILED DESCRIPTION

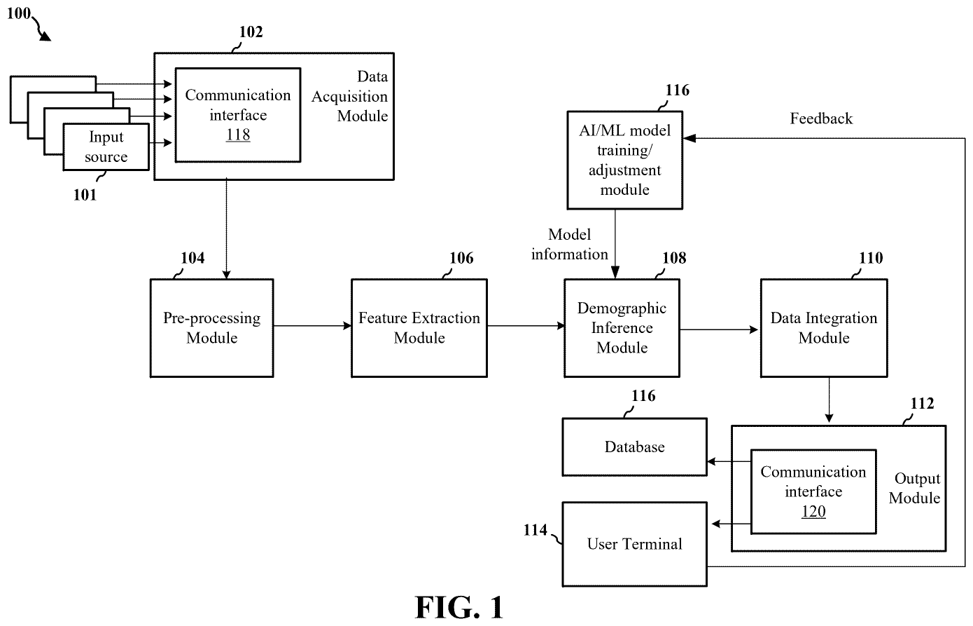

FIG. 1 illustrates an example system 100 for generating location-based demographic data by utilizing artificial intelligence (AI) image analysis techniques applied to geoencoded imagery. As shown in FIG. 1, the system may include a data acquisition module 102. The data acquisition module is configured to receive input data from one or more image sources. For example, one or more of the input sources may include geoencoded imagery (e.g., images), including satellite images, street view images, and/or other relevant image or data sources. A geoencoded image is an image that includes a number, symbol, word, words or other computer readable code referring to highly specific geographic location associated with the image. For example, the geographic information can be added through geocoding. The images and/or data are acquired and processed by the system.

The system 100 may include a preprocessing module 104 that is configured to perform pre-processing (e.g., processing before feature extraction and/or demographic inference). The pre-processing of the acquired images may include image processing to enhance image quality, adjust images to a particular format, or to otherwise prepare the images for analysis. Among various examples, such image processing by the pre-processing module 104 may include image normalization, noise reduction, and/or geometric correction, for example.

The system 100 may include a feature extraction module 106 that is configured to extract meaningful (e.g., particular) aspects or features (e.g., features or aspects that have been identified to affect a demographic analysis) from the processed images. Among other examples, extracted features may include one or more of facial features, clothing styles, architectural attributes, vegetation, light, buildings, vehicles, messages/text on signs, and/or other visual cues relevant to demographic characteristics. In some aspects, the feature extraction module 106 may use AI/ML aspects to extract meaningful features from the input images. As described in more detail herein, the feature extraction module 106 may use artificial intelligence or machine learning, such as a convolutional neural network (CNN) and/or other deep learning techniques, to extract meaningful features from the images (e.g., to extract types of features from the images that have been identified, flagged, indication, previously determine, or otherwise have been associated with having a relationship to demographic characteristics).

The system 100 includes a demographic inference module 108 that is configured to analyze the extracted features to infer demographic information such as age, gender, ethnicity, socioeconomic status, and/or occupation from the images. This inference can be based on a model that associates image patterns with different demographic considerations. As an example, the inference can be based on one or more trained AI models capable of recognizing patterns associated with different demographic groups, for example.

The system 100 may include a data integration module 110 that is configured to integrate the inferred demographic data with geographic information systems (GIS) data, e.g., for a geographic location associated with the analyzed image. The integration of the demographic data with the GIS data allows for the generation of location-based demographic profiles.

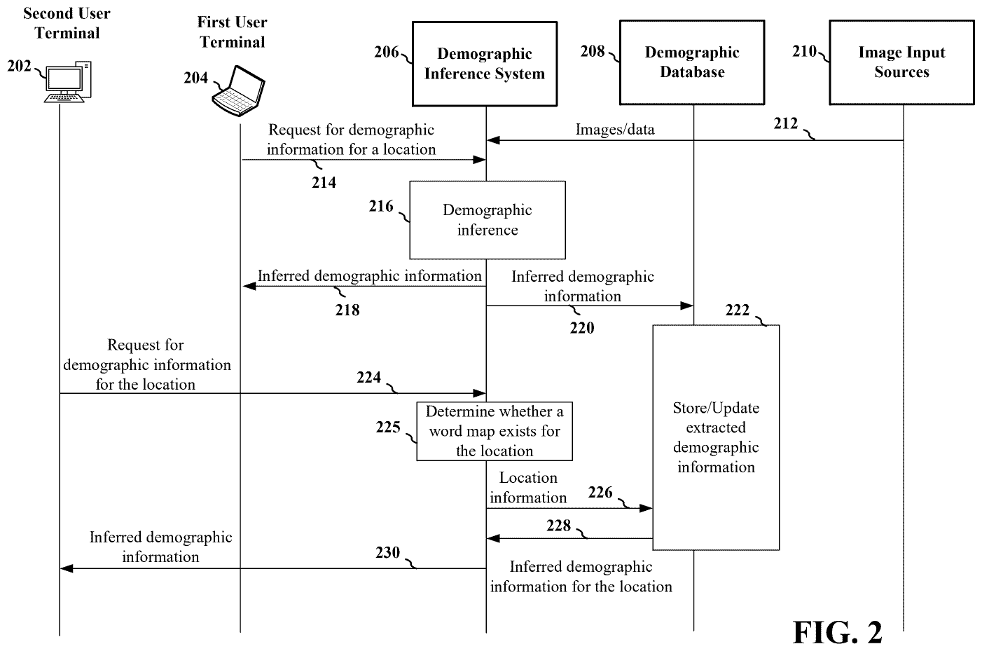

The system 100 may include an output module 112 configured to provide comprehensive reports, visualizations, and/or data sets summarizing the demographic characteristics of various locations based on the analyzed imagery. In some aspects, the output module 112 may output the report(s), visualization(s), and/or data sets to a user terminal 114, e.g., in response to a request for the demographic information that is received from the user terminal. As an example, the system may perform an analysis of geoencoded imagery to provide textural data and/or object associated with geographic locations based on the image analysis. In some aspects, the output module 112 may output the report(s), visualization(s), and/or data sets to a database 117 that stores the demographic information and/or integrated data determined for a particular geographic location (e.g., based on the image analysis of one or more images of the geographic location). Thus, the system may build, in a targeted, efficient manner, a database that includes demographic information (e.g., which may include demographic profiles) associated with geographic locations/areas. In some aspects, the system may be provided as part of a tool that assists a business or other entity in offering services that meet the needs of demographics in particular areas. Various aspects of such a system are described in connection with FIG. 2, for example.

The storage in a database 117 enables the information to be maintained and provided to a different user in response to a later request. This enables the system to build and maintain a database of inferred demographic information from images that can be provided to various users upon request. By storing the demographic data and/or integrated data as it is created in response to user requests, a database can be created in a targeted manner that enables more efficient responses to future requests. By building the database based on user requests, the analysis can be more targeted to user relevant information. The storage avoids repetitive analysis or processing and helps to streamline the operation and use of the system, e.g., reducing processing loads and reducing latency for providing users with information in response to future requests. For example, this enables the information to be generated on demand and stored for later requests rather than involving processing of images of an entire region before any user requests for information are received.

The AI/ML model that is used to infer the demographic information may be trained for demographic inference from images. FIG. 1 illustrates that the system may include, or be associated with, an AI/ML module training or adjustment module 116. For example, the demographic inference system may analyze training image data and known demographic information for the training image data and create a model based on: targets to be achieved, data relations, parameters and/or weights that may also be provided as input to create the model. The training data may include training images and target demographic information to be inferred from the training images. The demographic inference system may continue to acquire and analyze additional data such as geographical maps or satellite images to and/or feedback information about provided inferred demographic information to continue to refine and adjust the model. For example, the inferences made on the additional image data may be reviewed and feedback may be provided to the model to further refine the inferences. Statistical and demographics data about an area (e.g., a geographic area at which a training image or additional image is taken) may also be received as input to the model to contribute to train the model. After the model is trained, the model may be used to make demographic inferences from one or more input images of a particular geographic location or geographic area. As described herein, the inferred demographic information may be output, provided, and/or reported to a user in response to a request or in response to input of the image(s). The inferred demographic information may also be stored to create a demographic profile database that can be used to provide later responses to user request in a more efficient manner.

As illustrated, in FIG. 1, feedback about the demographic information may be provided as feedback to an AI/ML module training or adjustment module 116, which may make adjustments to the model used for feature extraction and/or demographic inference to improve accuracy based on the feedback.

FIG. 1 illustrates that the data acquisition module 102 may include, or receive the input, via a communication interface 118 that is configured to receive the input data from one or more input sources (e.g., which may include remote terminals). FIG. 1 also illustrates that the output module 112 may include or provide output via a communication interface 120. As an example, the communication interface may include a network interface, a communications port, and/or other components to enable the exchange of communication via a communication path (e.g., whether wire, cable, fiber optic, wireless link, and/or other communication channel between computer systems). Although illustrated as separate communication interfaces (e.g., 118 and 120), in some aspects, the system may include a communication interface that is shared by the data acquisition module 102 and the output module 112.

By leveraging AI image analysis, the system may achieve a high level of accuracy in demographic inference compared to other types of analysis. The automated image analysis reduces the time and resources to generate location-based demographic data, e.g., providing a toll that sends more efficient responses to a user request. The system includes scalability and can process large volumes of geoencoded imagery efficiently, making it suitable for diverse applications and geographic scales.

The aspects presented herein present a pioneering approach to generating location-based demographic data using AI image analysis of geoencoded imagery. By combining advanced machine learning techniques with geographic information, the system offers unprecedented insights into the demographic characteristics of various locations, empowering decision-makers across multiple domains.

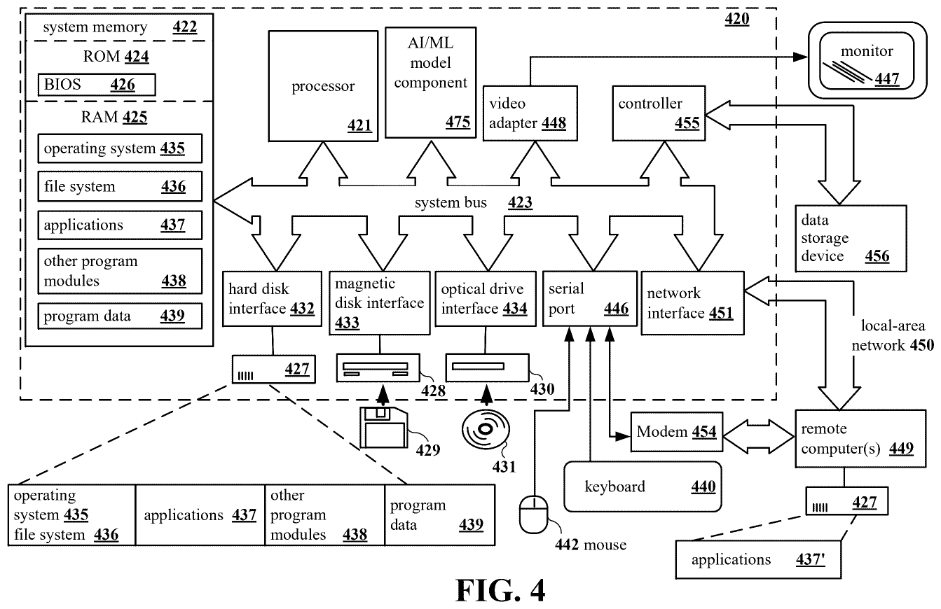

FIG. 2 illustrates an example of operation of a system for inference of demographic information, as presented herein. In FIG. 2, the demographic inference system 206 may include any of the aspects and/or modules described in connection with FIG. 1. The demographic inference system 206 receives images 212 and/or other data from one or more sources 210. For example, a data acquisition module 102 may receive satellite images, street view images, and/or other relevant image or data sources 101, as illustrated in FIG. 1. The image input may be received via a communication interface, e.g., including any of the aspects described in connection with FIG. 4, for example. In some aspects, the images may be input in connection with a user request. In some aspects, the system may constantly, or periodically receive additional or updated image information. In some aspects, the system may send a request for, or otherwise search/obtain, image information in response to a particular user request. A first user may send, via a first user terminal 204, a request 214 for demographic information for a particular geographic location or area. The request may be entered at a user interface provided via the system, for example. As an example, the location may be smaller than a zip code, such as for a neighborhood, or a range of addresses along a street. In response to receiving the request, the demographic inference system may obtain, or generate, the requested information. For example, the demographic inference system 206 may obtain images for the indicated location and may use an AI/ML model to infer demographic information from the images. Although the images 212 are illustrated as being received prior to the request 214, in some aspects, the demographic inference system 206 may request the images from the image input sources 210 based on the request 214. As part of inferring the demographic information at 216, the demographic inference system 206 may perform any of the processing aspects described in connection with FIG. 1 (e.g., pre-processing, feature extraction, analysis of extracted features to infer demographic information, and/or the integration of the demographic information with geographic data) to create location based demographic profiles for one or more geographic locations based on the images. At 218, the demographic inference system 206 outputs, e.g., provides, the requested demographic information 218 based on the inference at 216. The requested demographic information may be provided to the first user by displaying the information to the user via a user interface, in some aspects. In some aspects, the information may be transmitted to the user in a message or otherwise communicated to the user.

The system may also maintain a demographic database 208, e.g., providing the information 220 that was generated in response to the request 214, to the database 208, where the demographic information for various locations is stored and/or updated, as shown at 222. As an example, the previously inferred demographic information may be stored with corresponding latitude and longitude information. In some aspects, demographic profiles may be identified for various geographic zones. A profile may be based on a single demographic criterion or may be based on a combination of demographic criteria. In some aspects, the different geographic zones may be associated with a classification or identifier based on the profile determined for the geographic zone.

Then, when a later request 224 is received from a second user terminal 202 for demographic information for the same geographic location, the demographic inference system 206 may make a determination, at 225, as to whether a word map of demographic inference information already exists (e.g., was already generated and is stored at 222). If the system determines that the word map with the information is stored, the system may obtain the previously inferred demographic information that is stored at the database 208, e.g., as shown at 226 and 228, and may provide the inferred demographic information to the second user terminal 202 at 230. If the system determines that the word map for the requested location has not yet been generated, the system may build the information (e.g., infer the demographic information), as described for the example 216. In some aspects, in order to generate the inferred demographic information, the system may request, or otherwise obtain additional images and/or data for the location.

As the demographic information can be inferred in response to a request for a particular location, the service for location specific demographic information can be provided without performing inferences for an entire region, because the database can be built over time based on previously handled requests. Additionally, as images may change over time, the system may continue to receive updated images and may perform updated inferences of demographic information to maintain current demographic information.

As one, non-limiting example of a request, a cable company may request demographic information for a neighborhood or an area covered by a set of residential streets, as an example, in order to assess a potential marketing campaign to provide cable service to the geographic location. The inferred demographic information may assist the cable company in determining if the target audience for the service campaign matches the demographic information, and/or may assist the cable company in selecting a marketing campaign based on the demographic information. By determining the demographic information, the cable company may be able to select a marketing campaign for services that are more likely to meet the needs of the potential customers and to interest a higher number of new customers.

The inference of the demographic information from images for a particular location, in FIG. 1 and/or FIG. 2 may be based on an Artificial Intelligence (AI) or machine learning (ML) model. AI may refer to a set of software modules that constantly analyze data and propose actions for successful completion of a task or improving quality of a service. ML may refer to a constant improvement of the probability for success by receiving new data and correcting the mathematical and logical models. FIG. 4 illustrates an example system that includes an AI/ML model component 475 that can be configured to the model based analysis of images to derive demographic profile information and to output the demographic profile information in response to a user request.

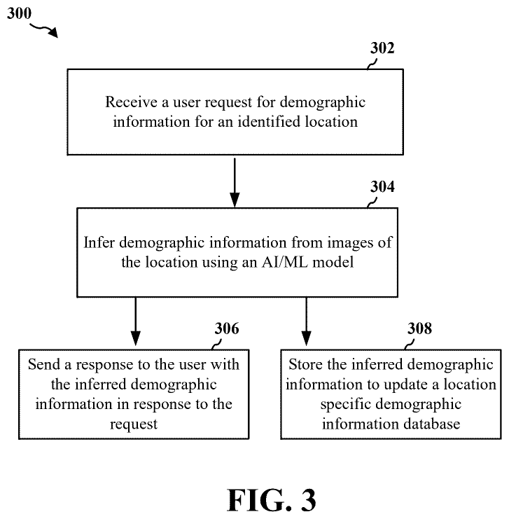

FIG. 3 illustrates an example flowchart 300 showing a method of providing inferred demographic information in response to a user request. The method may be performed by a system that includes aspects described in connection with any of FIGS. 1, 2, and/or 4, for example. In some aspects, one or more of the aspects of the flowchart in FIG. 1 may be performed by the AI/ML component 475, which may be configured to perform the aspects described in connection with any of FIGS. 1-3.

At 302, the system receives, at a communication interface of a demographic inference system, a user request for demographic information for an identified geographic location. For example, the request may correspond to the request 214 in FIG. 2.

At 304, the system infers demographic information for the identified location based on one or more images of the identified location. For example, the inference may include any of the aspects described in connection with 216 in FIG. 2. The inference may include aspects described in connection with 108 in FIG. 1. The inference may include additional aspects described in connection with FIGS. 1 and/or 2, for example. In some aspects, inferring demographic information includes analyzing features extracted from the one or more images using an artificial intelligence or machine learning (AI/ML) model to infer the demographic information from the one or more images. In some aspects, the AI/ML model is trained for demographic inference from geoencoded images.

At 306, the system sends a response to the user request, via the communication interface, with inferred demographic information for the identified location. The response may include aspects described in connection with 218, in some aspects. The response may be provided, e.g., by the output module 112 in FIG. 1, in some aspects.

In some aspects, as shown at 308, the system may further store, in a central database, the inferred demographic information with latitude and longitude information for the identified location. FIGS. 1 and 2 illustrate example aspects of storing inferred demographic information in a database.

In some aspects, the system may further receive, at the communication interface of the demographic inference system, an additional user request for the demographic information for the identified geographic location. As described in connection with an example in FIG. 2, the system may obtain the inferred demographic information stored for the identified location at the central database and send an additional response to the additional user request, with the inferred demographic information for the identified location. By storing the previously created demographic profile information in a database and accessing the stored information rather than performing an analysis of image data, the system avoids repetitive processing and provides more streamlined response in a more time efficient manner. As well, by building the database with information that has been previously requested by users, the database can be generated, and built, in a targeted way that avoids overloading the system by analyzing images for a more comprehensive area and by avoiding unnecessary processing of image data for geographic locations for which a user might not send a later request.

In some aspects, the system may further obtain the one or more images from remote source(s), wherein the one or more images comprise at least one of a satellite image or a street view image for the identified location. As an example, the data acquisition module 102 may obtain the one or more images, as described in connection with FIG. 1 and/or FIG. 2.

In some aspects, the system may further pre-process the one or more images including one or more of image normalization, noise reduction, and/or geometric correction. As an example, the pre-processing module 104 may pre-process the one or more images, as described in connection with FIG. 1 and/or FIG. 2.

In some aspects, the system may further perform feature extraction from the one or more images, after pre-processing, to extract features that affect a demographic inference. As an example, the feature extraction module 106 may extract the relevant features, as described in connection with FIG. 1 and/or FIG. 2.

In some aspects, the system may further integrate the inferred demographic information with GIS data to generate a location-based demographic profile. As an example, the data integration module 110 may perform the integration, as described in connection with FIG. 1 and/or FIG. 2.

These method and apparatus are described and illustrated using blocks, components, circuits, processes, algorithms, which may be referred to as “elements”. Such elements may be implemented using electronic hardware, computer software, or any combination thereof.

By way of example, an element, or any portion of an element, or any combination of elements may be implemented as a “processing system” that includes one or more processors. When multiple processors are implemented, the multiple processors may perform the functions individually or in combination, e.g. may be configured to perform the various functionality described herein. One or more processors in the processing system may execute software. Software, whether referred to as software, firmware, middleware, microcode, hardware description language, etc. means instructions, instruction sets, code, code segments, program code, programs, subprograms, software components, applications, software applications, software packages, routines, subroutines, objects, executables, threads of execution, procedures, functions, or any combination thereof.

The aspects described in connection with any of FIGS. 1-3 may be implemented in hardware, software, or any combination thereof. If implemented in software, the functions may be stored on or encoded as one or more instructions or code on a computer-readable medium (e.g., which may be referred to as a non-transitory computer-readable medium). Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

In some aspects, an AI/ML model may use machine-learning algorithms, deep-learning algorithms, neural networks, reinforcement learning, regression, boosting, or advanced signal processing methods for receiving content and identifying content of interest for particular users.

In some aspects, the AAI system may use machine-learning algorithms, deep-learning algorithms, neural networks, reinforcement learning, regression, boosting, or advanced signal processing methods for receiving content, identifying potential problems or improves, and outputting proposals to customers.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the central processing system and/or the AI/ML model at each of the remote customer systems include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes. Neuron model connections may be modeled as weights, in some aspects. A machine learning model may be adapted, e.g., based on external or internal information processed by the machine learning model. In some aspects, a machine learning model may include a non-linear statistical data model and/or a decision making model. Machine learning may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning. During training, the machine learning model may be presented with an input that the model uses to compute to produce an output. The actual output may be compared to a target output, and the difference may be used to adjust parameters (e.g., weights, biases, coefficients, etc.) of the machine learning model in order to provide an output closer to the target output. Before training, the output may not be correct or may be less accurate. A difference between the output and the target output, may be used to adjust weights of a machine learning model to align the output is more closely with the target.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

FIG. 4 is a block diagram illustrating a general-purpose computer system 420 on which aspects of systems and methods for providing inferred demographic information based on images in response to a user request, e.g., as described in connection with any of FIGS. 1-3 may be implemented in accordance with an example aspect. The computer system 420 can correspond to a physical server(s) on which AAI system is employed, for example.

As shown, the computer system 420 (which may be a personal computer or a server) includes a central processing unit 421, a system memory 422, and a system bus 423 connecting the various system components, including the memory associated with the central processing unit 421. As will be appreciated by those of ordinary skill in the art, the system bus 423 may comprise a bus memory or bus memory controller, a peripheral bus, and a local bus that is able to interact with any other bus architecture. The system memory may include permanent memory (ROM) 424 and random-access memory (RAM) 425. The basic input/output system (BIOS) 426 may store the basic procedures for transfer of information between elements of the computer system 420, such as those at the time of loading the operating system with the use of the ROM 424.

The computer system 420 may also comprise a hard disk 427 for reading and writing data, a magnetic disk drive 428 for reading and writing on removable magnetic disks 429, and an optical drive 430 for reading and writing removable optical disks 431, such as CD-ROM, DVD-ROM and other optical media. The hard disk 427, the magnetic disk drive 428, and the optical drive 430 are connected to the system bus 423 across the hard disk interface 432, the magnetic disk interface 433, and the optical drive interface 434, respectively. The drives and the corresponding computer information media are power-independent modules for storage of computer instructions, data structures, program modules, and other data of the computer system 420.

An example aspect comprises a system that uses a hard disk 427, a removable magnetic disk 429 and a removable optical disk 431 connected to the system bus 423 via the controller 455. It will be understood by those of ordinary skill in the art that any type of media 456 that is able to store data in a form readable by a computer (solid state drives, flash memory cards, digital disks, random-access memory (RAM) and so on) may also be utilized.

The computer system 420 has a file system 436, in which the operating system 435 may be stored, as well as additional program applications 437, other program modules 438, and program data 439. A user of the computer system 420 may enter commands and information using keyboard 440, mouse 442, or any other input device known to those of ordinary skill in the art, such as, but not limited to, a microphone, joystick, game controller, scanner, etc. Such input devices typically plug into the computer system 420 through a serial port 446, which in turn is connected to the system bus, but those of ordinary skill in the art will appreciate that input devices may be also be connected in other ways, such as, without limitation, via a parallel port, a game port, or a universal serial bus (USB). A monitor 447 or other type of display device may also be connected to the system bus 423 across an interface, such as a video adapter 448. In addition to the monitor 447, the personal computer may be equipped with other peripheral output devices (not shown), such as loudspeakers, a printer, etc.

Computer system 420 may operate in a network environment, using a network connection to one or more remote computers 449. The remote computer (or computers) 449 may be local computer workstations or servers comprising most or all of the aforementioned elements in describing the nature of a computer system 420. Other devices may also be present in the computer network, such as, but not limited to, routers, network stations, peer devices or other network nodes.

Network connections can form a local-area computer network (LAN) 450 and a wide-area computer network (WAN). Such networks are used in corporate computer networks and internal company networks, and they generally have access to the Internet. In LAN or WAN networks, the computer system 420 is connected to the local-area network 450 across a network adapter or network interface 451. When networks are used, the computer system 420 may employ a modem 454 or other modules well known to those of ordinary skill in the art that enable communications with a wide-area computer network such as the Internet. The modem 454, which may be an internal or external device, may be connected to the system bus 423 by a serial port 446. It will be appreciated by those of ordinary skill in the art that said network connections are non-limiting examples of numerous well-understood ways of establishing a connection by one computer to another using communication modules.

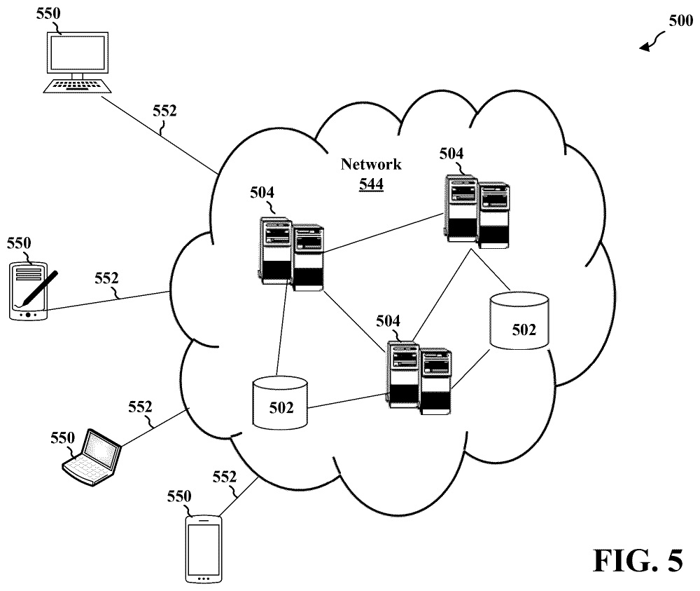

FIG. 5 shows an example communication system 500 usable in connection with aspects described herein for the demographic inference system (e.g., such as the demographic inference system 206 and/or the system 100). The communication system 500 may be a part of, or used to implement any of the aspects described in connection with FIGS. 1-4. For example, the computer system 420 may include aspects of the communication system 500, and/or may have a communication interface with the communication system 500. The communication system 500 includes one or more accessors (also referred to interchangeably herein as one or more “users,” people, or person) and one or more terminals 550. In one aspect, data for use in accordance aspects presented herein, for example, input and/or accessed by accessors via terminals 550, such as personal computers (PCs), minicomputers, mainframe computers, microcomputers, telephonic devices, or wireless devices, such as personal digital assistants (“PDAs”) or a hand-held wireless devices coupled to one or more servers 504 such as a PC, minicomputer, mainframe computer, microcomputer, or other device having a processor and a repository for data and/or connection to a repository 502 for data, via, for example, a network 544, such as the Internet or an intranet, and couplings 552. The computer system 520 including the demographic inference system 206, the demographic database 208, and/or the image input sources 210 may be comprised in the network 544, e.g., including one or more servers 504 or data repositories 502, or accessible via the network. The data repositories may include storage that provides non-volatile, bulk or long term storage of data or instructions in the demographic inference system. The storage may take the form of a disk, tape, CD, DVD, or other reasonably high capacity addressable or serial storage medium. Multiple storage devices may be provided or available, and some include network storage or cloud-based storage.

The couplings 552 may include, for example, wired, wireless, or fiberoptic links. For example, the couplings may be part of a communications interface with the demographic inference system. Such a communication interface allows software and data to be transferred between the demographic inference system and external devices, e.g., 550. Examples of communications interfaces may include a modem, a network interface (such as an Ethernet card), a communications port, a Personal Computer Memory Card International Association (PCM CIA) slot and card, etc. Data transferred via communications interface can be in the form of signals, which may be electronic, electromagnetic, optical or other signals capable of being received by the communications interface. These signals may be provided to communications interface via a communications path (e.g., channel). This path carries signals and may be implemented using wire or cable, fiber optics, a telephone line, a cellular link, a radio frequency (RF) link and/or other communications channels.

In another aspect, the methods and system presented herein may operate in a stand- alone environment, such as on a single terminal.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (A SIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

In one configuration, the ML/AI model component 475 and/or the computer system 420, and in particular, the file system 436 and/or the processor 421, is configured to perform the aspects described in connection with any of FIGS. 1-3. In some aspects, the ML/AI component 475 may include one or more of the data acquisition module 102, the pre-processing module 104, the feature extraction module 106, the demographic inference module 108, the data integration module 110, the AI/ML module training or adjustment module 116, the database 117, and/or the output module 112 described in connection with FIG. 1.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

Aspect 1 is a computer-implemented method for operation of a demographic inference system, comprising: receiving, at a communication interface of a demographic inference system, a user request for demographic information for an identified geographic location; inferring demographic information for the identified location based on one or more images of the identified location; and sending a response to the user request, via the communication interface, with inferred demographic information for the identified location.

In aspect 2, the method of aspect 1 further includes storing, in a central database, the inferred demographic information with latitude and longitude information for the identified location.

In aspect 3, the method of aspect 2 further includes receiving, at the communication interface of the demographic inference system, an additional user request for the demographic information for the identified geographic location; and determining whether the demographic information for the identified geographic location has been previously inferred.

In aspect 4, the method of aspect 3 further includes obtaining the inferred demographic information stored for the identified location at the central database, in response to determining that the demographic information was previously inferred; and sending an additional response to the additional user request, with the inferred demographic information for the identified location.

In aspect 5, the method of any of aspects 1-4 further includes obtaining the one or more images from remote sources, wherein the one or more images comprise at least one of a satellite image or a street view image for the identified location.

In aspect 6, the method of any of aspects 1-5 further includes pre-processing the one or more images including one or more of image normalization, noise reduction, and/or geometric correction.

In aspect 7, the method of aspect 6 further includes performing feature extraction from the one or more images, after pre-processing, to extract features that affect a demographic inference.

In aspect 8, the method of any of aspects 1-7 further includes inferring demographic information includes analyzing features extracted from the one or more images using an AI/ML model to infer the demographic information from the one or more images.

In aspect 9, the method of aspect 8 further includes that the AI/ML model is trained for demographic inference from geoencoded images.

In aspect 10, the method of any of aspects 1-9 further includes integrating the inferred demographic information with GIS data to generate a location-based demographic profile.

Aspect 11 is a demographic inference computer system comprising: a communication interface; memory; and one or more processors coupled to the memory and the communication interface, wherein the one or more processors, individually or in any combination, are configured to execute information stored in the memory to cause the demographic inference computer system to perform the method of any of aspects 1-10.

Aspect 12 is a non-transitory computer-readable medium storing computer executable code for a demographic inference system, the code when executed by processor circuitry causes the demographic inference system to perform the method of any of claims 1-10.

Aspect 13 is a demographic inference system comprising: a processing system that includes processor circuitry and memory circuitry that stores code and is coupled with the processor circuitry, the processing system configured to cause the system to: perform the method of any of aspects 1-10.

Aspect 14 is a demographic inference system comprising means for performing the method of any of aspects 1-10.

What is claimed is:

1. A demographic inference computer system, comprising:
a communication interface;
memory; and
one or more processors coupled to the memory and the communication interface, wherein the one or more processors are configured to execute information stored in the memory to cause the demographic inference computer system to:
receive, via the communication interface of a demographic inference system, a user request for demographic information for an identified geographic location;
infer, based on the identified geographic location in the user request, the demographic information for the identified geographic location based on one or more images of the identified geographic location; and
send a response to the user request, via the communication interface, with inferred demographic information for the identified geographic location.

2. The demographic inference computer system of claim 1, wherein the one or more processors are further configured to:
store, in a central database, the inferred demographic information with latitude and longitude information for the identified geographic location.

3. The demographic inference computer system of claim 2, wherein the one or more processors are further configured to:
receive, at the communication interface of the demographic inference system, an additional user request for the demographic information for the identified geographic location; and
determine whether the demographic information for the identified geographic location has been previously inferred.

4. The demographic inference computer system of claim 3, wherein the one or more processors are further configured to:
obtain the inferred demographic information stored for the identified geographic location at the central database, in response to determining that the demographic information was previously inferred; and
send an additional response to the additional user request, with the inferred demographic information for the identified geographic location.

5. The demographic inference computer system of claim 1, wherein the one or more processors are further configured to:
obtain the one or more images from a remote source, wherein the one or more images comprise at least one of a satellite image or a street view image for the identified geographic location.

6. The demographic inference computer system of claim 1, wherein the one or more processors are further configured to:
pre-process the one or more images including one or more of image normalization, noise reduction, or geometric correction on the one or more images prior to analysis for a demographic inference.

7. The demographic inference computer system of claim 6, wherein the one or more processors are further configured to:
perform feature extraction from the one or more images, after pre-processing, to extract features that affect the demographic inference.

8. The demographic inference computer system of claim 7, wherein inference of the demographic information includes analysis of features extracted from the one or more images using an artificial intelligence or machine learning (AI/ML) model to infer the demographic information from the one or more images.

9. The demographic inference computer system of claim 8, wherein the AI/ML model is trained for the demographic inference from geoencoded images.

10. The demographic inference computer system of claim 8, wherein the one or more processors are further configured to:
integrate the inferred demographic information with geographic information system (GIS) data to generate a location-based demographic profile.

11. A computer-implemented method for operation of a demographic inference system, comprising:
receiving, at a communication interface of the demographic inference system, a user request for demographic information for an identified geographic location;
inferring, based on the identified geographic location in the user request, the demographic information for the identified geographic location based on one or more images of the identified geographic location; and
sending a response to the user request, via the communication interface, with inferred demographic information for the identified geographic location.

12. The computer-implemented method of claim 11, further comprising:
storing, in a central database, the inferred demographic information with latitude and longitude information for the identified geographic location.

13. The computer-implemented method of claim 12, further comprising:
receiving, at the communication interface of the demographic inference system, an additional user request for the demographic information for the identified geographic location;
determining whether the demographic information for the identified geographic location has been previously inferred;
obtaining the inferred demographic information stored for the identified geographic location at the central database, in response to determining that the demographic information was previously inferred; and
sending an additional response to the additional user request, with the inferred demographic information for the identified geographic location.

14. The computer-implemented method of claim 11, further comprising:
obtaining the one or more images from a remote source, wherein the one or more images comprise at least one of a satellite image or a street view image for the identified geographic location.

15. The computer-implemented method of claim 11, further comprising:
pre-processing the one or more images including one or more of image normalization, noise reduction, and/or geometric correction.

16. The computer-implemented method of claim 15, further comprising:
performing feature extraction from the one or more images, after pre-processing, to extract features that affect a demographic inference.

17. The computer-implemented method of claim 16, wherein inferring the demographic information includes analyzing the features extracted from the one or more images using an artificial intelligence or machine learning (AI/ML) model to infer the demographic information from the one or more images.

18. The computer-implemented method of claim 17, wherein the AI/ML model is trained for the demographic inference from geoencoded images.

19. The computer-implemented method of claim 17, further comprising:
integrating the inferred demographic information with geographic information system (GIS) data to generate a location-based demographic profile.

20. A non-transitory computer-readable medium storing computer executable code for a demographic inference system, the code when executed by processor circuitry causes the demographic inference system to:
receive, at a communication interface of the demographic inference system, a user request for demographic information for an identified geographic location;
inferring, based on the identified geographic location in the user request, the demographic information for the identified geographic location based on one or more images of the identified geographic location; and
send a response to the user request, via the communication interface, with inferred demographic information for the identified geographic location.
